(19) United States
(12) Patent Application Publication
(10) Pub. No.: US 2026/0295545 A1
(43) Pub. Date: Oct. 1, 2026

(54) MICROFLUIDIC MIXING

(71) Applicant: SYNGENTA CROP PROTECTION AG, Basel (CH)

(72) Inventor: Matthias LEHMANN, Stein (CH)

(73) Assignee: SYNGENTA CROP PROTECTION AG, Basel (CH)

(21) Appl. No.: 19/478,599

(22) PCT Filed: Apr. 22, 2024
(86) PCT No.: PCT/EP2024/060878

§ 371 Date: Oct. 24, 2025

(30) Foreign Application Priority Data
Apr. 25, 2023 (EP) 23169880.4

(51) Int. Cl. B01F 33/3011; B01F 33/81

(52) U.S. Cl. CPC B01F 33/3011; B01F 33/811; B01F 33/813

(57) ABSTRACT

The present disclosure relates to microfluidic mixing. Aspects of the invention relate to microfluidic mixers, microfluidic mixer systems, methods of mixing and methods of manufacturing microfluidic mixers.

### TECHNICAL FIELD

The present disclosure relates to microfluidic mixing. Aspects of the invention relate to microfluidic mixers, microfluidic mixer systems, methods of mixing and methods of manufacturing microfluidic mixers.

### BACKGROUND

Microfluidic mixers use small structures and channels/ports in the micrometer scale regime to mix fluids e.g. to produce solutions (in the case of two homogeneously miscible fluids) or mixtures (in the case of immiscible fluids. Applications are wide and include for instance molecular analysis, chemical production and molecular biology. Microfluidic mixers have the potential to accelerate the mixing process into the millisecond to microsecond range and therefore significantly below the second range mixing times of typical batch mixers. Faster mixing can for example improve the yield and side-product profile of a rapid chemical synthesis.

Due to their small scale and the typically correspondingly low associated Reynolds numbers, most micromixers operate in the laminar flow regime and thus rely on diffusion as the mixing principle.

Diffusion does not require external energy input, and so mixers relying on diffusion can be more energy efficient than turbulent mixers.

To further refine microfluidic mixers, design improvements may be sought to improve at least one of mixing time, internal volume, pressure drop and energy consumption. Performance is often improved where structures and channels/ports can be reduced in size. However, it may be difficult to continue to reduce size given manufacturing resolution and quality. Further, increasing the volume of the product of mixing produced is generally achieved by increasing the scale, but this may lead to degradation in other performance areas (e.g. yield).

It is an object of embodiments of the invention to at least mitigate one or more of the problems of the prior art.

### SUMMARY OF THE INVENTION

According to a first aspect of the invention there is provided a microfluidic mixer arranged to mix a first fluid and a second fluid, the microfluidic mixer comprising a mixing chamber and fluid delivery conduits each having a respective fluid delivery port into the mixing chamber,
the fluid delivery conduits comprising at least one first fluid delivery conduit arranged to deliver the first fluid into the mixing chamber and at least one second fluid delivery conduit arranged to deliver the second fluid into the mixing chamber,
wherein the mixing chamber has a fluid delivery port portion having a cross-section that is at least substantially circular and the fluid delivery conduits are disposed radially outwards of the delivery port portion and such that the fluid delivery ports form a substantially continuous and substantially complete ring around the fluid delivery port portion,
and where further the at least one first fluid delivery conduit is arranged so that first fluid delivered by each of the first fluid delivery conduits forms a respective first flow in the mixing chamber and the at least one second fluid delivery conduit is arranged so that second fluid delivered by each of the second fluid delivery conduits forms a respective second flow in the mixing chamber,
and where the fluid delivery conduits are arranged so that the first and second flows are focussed at a substantially common focus point within the mixing chamber.

The adjacent fluid delivery conduits and ports surrounding the mixing chamber may mean that laminar flow is encouraged (e.g. with appropriate selection of flow rate under which the first and second fluids are delivered). In this laminar regime, mixing may be achieved by diffusion between the adjacent first and second flows. The convergence of the first and second flows at a common focus point may give rise to hydrodynamic focussing and so faster mixing. Because the fluid delivery ports form a substantially continuous and substantially complete ring around the fluid delivery port portion (e.g. high order rotational symmetry) several advantages may arise. First, there may be additional utilisation/throughput of fluid through the microfluidic mixer for given fluid delivery conduit sizing, given a mixing chamber into which fluid is injected from substantially all radial directions. Additionally, the conditions encountered by each first and second flow may be substantially consistent (e.g. only other adjacent flows travelling towards the focus point). The absence of rotational asymmetry may reduce or prevent asymmetrical flow characteristics and/or flow rates, which may improve mixing performance and/or reduce back pressure associated with the microfluidic mixer. Reductions in pressure drop may be advantageous in that smaller pumps and/or less energy may be needed. Improvements in mixing may offer higher yield of a product of a mixing process using the microfluidic mixer. The mixing chamber may for instance be substantially cylindrical in shape, though alternatives are possible. For instance, any shape offering a high order of rotational symmetry giving rise to a substantially circular cross-section at the fluid delivery port portion is possible (e.g. a regular octagon or regular shape with more sides).

In some embodiments the first and second fluids are different. They may for instance be of different chemical and/or biological nature. It may additionally or alternatively be that the first flows and second flows may comprise respectively the first and second fluids exclusively and/or at least not contain the other of the first and second fluid.

In some embodiments the substantially common focus point is located at substantially the centre of the mixing chamber. The substantially common focus point may for instance be positioned on substantially the same plane as the fluid delivery ports and/or may be positioned so as to be substantially equidistant the fluid delivery ports. Additionally or alternatively, the substantially common focus point may be positioned on an axis of substantial rotational symmetry for the mixing chamber. In this way, the similar path lengths that may be travelled by each first and second flow may mean that each of the first and second flows has a more consistent thickness, potentially resulting in improved mixing and reduced pressure drop.

In some embodiments the space inside the mixing chamber is rotationally symmetric. It may be for instance that the mixing chamber defines an uninterrupted cavity (e.g. without internal walls or other structures). The space inside the mixing chamber may in particular have no radially extending walls therein. The absence of internal structures may mean that the first and second flows are not interrupted or disturbed as they mix and travel to the substantially common focus point. Were radially extending walls to be present, there might for instance be ‘edge effects’ resulting from interaction between laminar flow and the wall.

In some embodiments the microfluidic mixer comprises a fluid collection conduit having a fluid collection port, where the fluid collection port is provided at the substantially common focus point and the fluid collection conduit is arranged to receive the product of mixing the first and second fluids in the mixing chamber. By locating the fluid collection conduit in this way, the first and second flows may flow substantially directly through and out of the mixing chamber (e.g. maintaining substantially straight line flow path and/or laminar flow and substantially without turbulent flow). Pressure drop may thus be reduced.

In some embodiments the fluid collection port is provided in an end wall of the mixing chamber or the fluid collection conduit passes through the end wall. Thus, the fluid collection conduit may transport the product of mixing away from the mixing chamber in a substantially axial direction. This may facilitate the absence of a substantially radially extending fluid collection conduit, which might inhibit the provision of a substantially continuous and substantially complete ring of fluid delivery ports around the fluid delivery port portion and/or might inhibit the provision of a substantially uninterrupted cavity within the mixing chamber. As will be appreciated, the product of mixing may be delivered by the fluid collection conduit to a store, for further processing or for use.

In some embodiments the fluid collection conduit may be dimensioned so as to introduce substantially no pressure drop to the microfluidic mixer. This may be appropriate where mixing has been sufficiently effective in the mixing chamber so that there is no need to generate further mixing in the fluid collection conduit.

In some embodiments the microfluidic mixer comprises multiple instances of each of the first fluid delivery conduit and the second fluid delivery conduit. With increasing numbers of fluid delivery conduits, there may be greater scope for laminar flow contact between instances of the first and second flows and therefore greater diffusion mixing.

In some embodiments the microfluidic mixer comprises sufficient fluid delivery conduits such that fluid flows delivered by adjacent instances of those conduits are substantially parallel. It may be for instance that there is only a small number of angular degrees or that there is only a fraction of an angular degree between the angles at which the main directions of adjacent fluid flows are delivered (the small difference in angles providing for the focussing).

In some embodiments the fluid delivery conduits are arranged such that they alternate between an instance of the first fluid delivery conduit and an instance of the second fluid delivery conduit in a circumferential direction. This may be desirable where increased mixing between the first and second fluids is desired. The fluid delivery conduits may be consistently dimensioned to thereby better facilitate consistent flow rates and mixing. In some embodiments the fluid delivery ports are between substantially 1 and 50 micrometres in width. In some embodiments, the fluid delivery ports are between substantially 1 and 25 micrometres in width. In some embodiments the fluid delivery ports are between substantially 1 and 10 micrometres in width. The widths of the fluid delivery ports may be significant in performance of the microfluidic mixer, with performance increasing with decreasing widths.

In some embodiments each first fluid delivery conduit connects its fluid delivery port to a first reservoir arranged to contain a supply of the first fluid. The microfluidic mixer may comprise a first fluid inlet arranged to deliver the first fluid to the first reservoir. In use, the first fluid may be supplied to the first reservoir under pressure by a first pump. The pressure may facilitate delivery of the first fluid to the mixing chamber via the first fluid delivery conduits. The first reservoir may be located so as to be axially displaced with respect to the mixing chamber. Additionally or alternatively, the first reservoir may be located to be on an opposite side of the mixing chamber to the fluid collection conduit. This may better facilitate the packaging of the microfluidic mixer in the sense that there may be no need to accommodate both the first reservoir and first fluid delivery thereto on a side of the mixing chamber from which the product of mixing is collected.

In some embodiments each second fluid delivery conduit connects its fluid delivery port to a second reservoir arranged to contain a supply of the second fluid. The microfluidic mixer may comprise a second fluid inlet arranged to deliver the second fluid to the second reservoir. In use, the second fluid may be supplied to the second reservoir under pressure by a second pump. The pressure may facilitate delivery of the second fluid to the mixing chamber via the second fluid delivery conduits. The first and second pumps may pressurise the respective reservoirs with substantially the same pressure, thereby facilitating delivery of the first and second fluids to the mixing chamber at substantially the same pressure. The second reservoir may be located so as to be axially displaced with respect to the mixing chamber. Additionally or alternatively, the second reservoir may be located to be on an opposite side of the mixing chamber to the fluid collection conduit. This may better facilitate the packaging of the microfluidic mixer in the sense that there may be no need to accommodate both the second reservoir and second fluid delivery thereto on a side of the mixing chamber from which the product of mixing is collected. The second reservoir may be located radially inward of the first reservoir. This may offer benefits in terms of accommodating both first and second reservoirs whilst reducing the lengths of the fluid delivery conduits and therefore pressure drop.

In some embodiments each fluid delivery conduit comprises a radially extending portion extending substantially radially outwards from its fluid delivery port at the mixing chamber. This may condition fluid within the fluid delivery conduit to travel in a substantially straight line/laminar manner towards the substantially common focus point when delivered via the corresponding fluid delivery port. Additionally, it may allow the fluid delivery conduit to clear the mixing chamber.

In some embodiments the radially extending portions are formed between radially extending walls each tapered substantially to a sharp edge or point at the mixing chamber. In view of the radially extending walls tapering substantially to a sharp edge or point, there may be substantially no gap between adjacent fluid delivery ports. This may encourage close proximity between the first and second flows and therefore mixing by diffusion in a laminar regime.

In some embodiments each fluid delivery conduit comprises an axially extending portion between the radially extending portion and the corresponding one of the first and second reservoirs.

In some embodiments at least part of the microfluidic mixer is formed by the removal of material from within a substrate block. Thus for instance, one/or more structures of the microfluidic mixer may be formed in this way e.g. one or more of the mixing chamber, the fluid delivery conduits, the fluid collection conduit, first reservoir, first fluid inlet, second reservoir and the second fluid inlet.

In some embodiments the material removal is performed by selective laser etching. Thus, parts of the internal structure of the substrate block to be manufactured to correspond to parts of the design of the microfluidic mixer constituting voids (e.g. the mixing chamber, the fluid delivery conduits, the fluid collection conduit, first reservoir, first fluid inlet, second reservoir and the second fluid inlet) may be irradiated around other non-void parts (e.g. walls of the mixing chamber, walls of the fluid delivery conduits (including the walls between the fluid delivery conduits), wall of the fluid collection conduit, wall of the first reservoir, wall of the first fluid inlet, wall of the second reservoir and wall of the second fluid inlet) within the substrate block. This may be followed by etching away the irradiated material (e.g. using a substance which etches the irradiated material at a faster rate than non-irradiated material). The irradiation may be by means of a focused femtosecond laser. The etching may be my means of potassium hydroxide. The selective laser etching process may offer benefits by comparison with alternatives such as two-photon polymerisation and photolithography. In particular, selective laser etching may allow for significantly finer structures and 3-dimensional structures to be manufactured and/or for them to be manufactured in a more cost effective manner. Finer structures (e.g. smaller fluid delivery port diameters) may offer improved mixing and therefore yields.

In some embodiments the substrate block comprises fused silica, glass, sapphire or another transparent material.

When using the microfluidic mixer, the first and second fluids could be reagents, with the microfluidic mixer being used to mix them to facilitate a chemical reaction. Alternatively, the microfluidic mixer may be used to mix the first and second fluids (as chemical species or otherwise) to produce a mixture. In some cases, the first and second fluids may be biological material and/or medicaments. The same microfluidic mixer might be used for any such purpose on different occasions.

According to a second aspect of the invention there is provided a microfluidic mixer system comprising multiple interconnected instances of the microfluidic mixer of the first aspect.

In some embodiments the multiple instances of the microfluidic mixer are interconnected in that their fluid collection conduits are arranged to deliver product of mixing to a common outlet. The common outlet may for instance be a common store or an inlet to a device or system for further processing or use. The multiple instances of the microfluidic mixer may therefore be considered to be arranged (e.g. connected) in parallel. Interconnection in this manner may allow for a significant increase in volume of product of mixing. This approach to increasing volume may give improved performance by comparison with commonly used alternatives such as scaling up the microfluidic mixer (which tends to result in a loss of mixing performance). The microfluidic mixer system, optionally including the common outlet, may be formed by the removal of material from within the substrate block. This again may be achieved by means of selective laser etching.

In some embodiments the multiple instances of the microfluidic mixer and their interconnections with the common outlet are arranged so that substantially the same pressure drop occurs for fluid flowing through each of the multiple instances of the microfluidic mixer to the common outlet. It may be for instances that each of the multiple instances of the microfluid mixer are substantially the same and/or have interconnection arrangements to the common outlet which are substantially the same. The multiple instances of the microfluidic mixers may for instance be arranged around the common outlet with interconnections of substantially the same form and dimensions. The microfluidic mixers may for instance be arranged at equally spaced intervals and/or symmetrically around (e.g. radially outwards of and/or in a common radial plane) the common outlet.

In some embodiments the multiple instances of the microfluidic mixer are interconnected in that the fluid collection conduit of a first of the microfluidic mixers is arranged to deliver product of mixing to the at least one first fluid delivery conduit of a second of the microfluidic mixers. This may for instance be via the first reservoir and optionally the first fluid inlet of the second microfluidic mixer. Additionally, this interconnection may be further repeated (e.g. to a third and optionally fourth and optionally so on instances of the microfluidic mixer). The multiple instances of the microfluidic mixer may therefore be considered to be arranged (e.g. connected) in series. Interconnection in this manner may allow for further (and if desired, rapid) microfluidic mixing processing of the product of mixing from the first microfluidic mixer. An example application for the microfluid mixer system of this nature is where it is desired to mix the product of mixing of the first microfluidic mixer with a third fluid (e.g. a quench reagent to (e.g. rapidly) stop the reaction begun by mixing the first and second fluids in the first microfluidic mixer). The microfluidic mixer system may be formed by the removal of material from within the substrate block. This again may be achieved by means of selective laser etching. In some embodiments the third fluid is different to the first and/or the second fluids. They may for instance be of different chemical and/or biological nature.

In some embodiments, the series and parallel arrangements described above may be combined in any order or combination. For example, multiple instances of the microfluidic mixer may deliver product of mixing to a common outlet, which delivers the product of mixing to at least one first fluid delivery conduit of another of the microfluidic mixers (or for that matter to a number of the microfluidic mixers again connected in parallel).

According to a third aspect of the invention there is provided a method of mixing a first fluid and a second fluid in a microfluidic manner, the method comprising, delivering a first fluid in at least one first flow and a second fluid in at least one second flow from positions which define a substantially continuous and substantially complete ring of a substantially circular shape towards a substantially common focus point.

According to a fourth aspect of the invention there is provided a microfluidic mixer formed by the removal of material from within a substrate block by selective laser etching.

The selective laser etching may offer benefits in terms of microfluidic mixer manufacture by comparison with alternatives such as photolithography. In particular, selective laser etching may allow for significantly finer structures to be manufactured and/or for them to be manufactured in a more cost effective manner. Finer structures in a microfluidic mixer may offer improved mixing and therefore yields.

The selective laser etching may be performed by irradiating parts of the inside of the substrate block that in accordance with the microfluidic mixer design are to constitute voids. These parts may be irradiated around other non-void parts of the design. This may be followed by etching away the irradiated material (e.g. using a substance which etches the irradiated material at a faster rate than non-irradiated material). The irradiation may be by means of a femtosecond laser. The etching may be my means of potassium hydroxide.

In some embodiments the substrate block comprises glass, sapphire or another transparent material.

In some embodiments the microfluidic mixer is arranged to mix a first fluid and a second fluid, the microfluidic mixer comprising a mixing chamber and fluid delivery conduits each having a respective fluid delivery port into the mixing chamber, the fluid delivery conduits comprising at least one first fluid delivery conduit arranged to deliver the first fluid into the mixing chamber and at least one second fluid delivery conduit arranged to deliver the second fluid into the mixing chamber and where the at least one first fluid delivery conduit is arranged so that first fluid delivered by each of the first fluid delivery conduits forms a respective first flow in the mixing chamber and the at least one second fluid delivery conduit is arranged so that second fluid delivered by each of the second fluid delivery conduits forms a respective second flow in the mixing chamber, where each first flow is adjacent to at least one of the second flows or another of the first flows and each second flow is adjacent to at least one of the first flows or another of the second flows and where the fluid delivery conduits are arranged so that the first and second flows are focussed at a substantially common focus point within the mixing chamber.

The adjacent fluid delivery conduits and ports surrounding the mixing chamber may mean that laminar frow is encouraged (e.g. with appropriate selection of pressure under which the first and second fluids are delivered). In this laminar regime, mixing may be achieved by diffusion between the adjacent first and second flows. The convergence of the first and second flows at a common focus point may give rise to hydrodynamic focussing and so improved mixing.

In some embodiments the mixing chamber has a fluid delivery port portion having a cross-section that is at least a segment of a substantially circular shape, where the fluid delivery conduits are disposed radially outwards of the delivery port portion and such that the fluid delivery ports are disposed around the delivery port portion. The chamber may for instance be substantially a segment of a cylinder or substantially a cylinder.

In some embodiments the mixing chamber has a fluid delivery port portion having a cross-section that is at least substantially circular and the fluid delivery conduits are disposed radially outwards of the delivery port portion and such that the fluid delivery ports form a substantially continuous and substantially complete ring around the fluid delivery port portion.

In some embodiments the substantially common focus point is located at substantially the centre of the mixing chamber. The substantially common focus point may for instance be positioned on substantially the same plane as the fluid delivery ports and/or may be positioned so as to be substantially equidistant the fluid delivery ports. Additionally or alternatively, the substantially common focus point may be positioned on an axis of substantial rotational symmetry for the mixing chamber.

In some embodiments the space inside the mixing chamber is rotationally symmetric. It may be for instance that the mixing chamber defines an uninterrupted cavity (e.g. without internal walls or other structures). The space inside the mixing chamber may in particular have no radially extending walls therein.

In some embodiments the microfluidic mixer comprises a fluid collection conduit having a fluid collection port, where the fluid collection port is provided at the substantially common focus point and the fluid collection conduit is arranged to receive the product of mixing the first and second fluids in the mixing chamber. By locating the fluid collection conduit in this way, the first and second flows may flow substantially directly through and out of the mixing chamber (e.g. maintaining substantially straight line flow paths and/or laminar flow and substantially without turbulent flow).

In some embodiments the fluid collection conduit may be dimensioned so as to introduce substantially no pressure drop to the microfluidic mixer. This may be appropriate where mixing has been sufficiently effective in the mixing chamber so that there is no need to generate further mixing in the fluid collection conduit.

In some embodiments the microfluidic mixer comprises multiple instances of each of the first fluid delivery conduit and the second fluid delivery conduit.

In some embodiments the microfluidic mixer comprises sufficient fluid delivery conduits such that fluid flows delivered by adjacent instances of those conduits are substantially parallel.

In some embodiments the fluid delivery conduits are arranged such that they alternate between an instance of the first fluid delivery conduit and an instance of the second fluid delivery conduit in a circumferential direction. The fluid delivery conduits may be consistently dimensioned to better facilitate consistent flow rates and mixing. In some embodiments the fluid delivery ports are between substantially 1 and 50 micrometres in width. In some embodiments, the fluid delivery ports are between substantially 1 and 25 micrometres in width. In some embodiments the fluid delivery ports are between substantially 1 and 10 micrometres in width. The widths of the fluid delivery ports may be significant in performance of the microfluidic mixer, with performance increasing with decreasing widths.

In some embodiments each first fluid delivery conduit connects its fluid delivery port to a first reservoir arranged to contain a supply of the first fluid. The microfluidic mixer may comprise a first fluid inlet arranged to deliver the first fluid to the first reservoir. In use, the first fluid may be supplied to the first reservoir under pressure by a first pump. The pressure may facilitate delivery of the first fluid to the mixing chamber via the first fluid delivery conduits. The first reservoir may be located so as to be axially displaced with respect to the mixing chamber. Additionally or alternatively, the first reservoir may be located to be on an opposite side of the mixing chamber to the fluid collection conduit. This may better facilitate the packaging of the microfluidic mixer in the sense that there may be no need to accommodate both the first reservoir and first fluid delivery thereto on a side of the mixing chamber from which the product of mixing is collected (e.g. in the case of a substantially axial fluid collection conduit).

In some embodiments each second fluid delivery conduit connects its fluid delivery port to a second reservoir arranged to contain a supply of the second fluid. The microfluidic mixer may comprise a second fluid inlet arranged to deliver the second fluid to the second reservoir. In use, the second fluid may be supplied to the second reservoir under pressure by a second pump. The pressure may facilitate delivery of the second fluid to the mixing chamber via the second fluid delivery conduits. The first and second pumps may pressurise the respective reservoirs with substantially the same pressure, thereby facilitating delivery of the first and second fluids to the mixing chamber at substantially the same pressure. The second reservoir may be located so as to be axially displaced with respect to the mixing chamber. In some embodiments, the second reservoir may be located to be on an opposite side of the mixing chamber to the fluid collection conduit. This may better facilitate the packaging of the microfluidic mixer in the sense that there may be no need to accommodate both the second reservoir and second fluid delivery thereto on a side of the mixing chamber from which the product of mixing is collected (e.g. in the case of a substantially axial fluid collection conduit). The second reservoir may be located radially inward of the first reservoir. This may offer benefits in terms of accommodating both first and second reservoirs whilst reducing the lengths of the fluid delivery conduits and therefore pressure drop. In other embodiments the second reservoir may be located on an opposite side of the mixing chamber to the first reservoir. This may better facilitate the packaging of the microfluidic mixer where the first and second fluid inlets are arranged to supply their respective reservoirs in substantially axial directions from opposite sides.

In some embodiments each fluid delivery conduit comprises a radially extending portion extending substantially radially outwards from its fluid delivery port at the mixing chamber.

In some embodiments the radially extending portions are formed between radially extending walls each tapered substantially to a sharp edge or point at the mixing chamber. In view of the radially extending walls tapering substantially to a sharp edge or point, there may be substantially no gap between adjacent fluid delivery ports. This may encourage close proximity between the first and second flows and therefore mixing by diffusion in a laminar regime.

In some embodiments each fluid delivery conduit comprises an axially extending portion between the radially extending portion and the corresponding one of the first and second reservoirs.

In some embodiments the fluid collection port is provided in an end wall of the mixing chamber or the fluid collection conduit passes through the end wall. Thus, the fluid collection conduit may transport the product of mixing away from the mixing chamber in a substantially axial direction. As will be appreciated, the product of mixing may be delivered by the fluid collection conduit to a store, for further processing or for use.

In some embodiments the fluid collection conduit passes through a side wall of the mixing chamber. Thus, the fluid collection conduit may transport the product of mixing away from the mixing chamber in a substantially radial direction. As will be appreciated, the product of mixing may be delivered by the fluid collection conduit to a store, for further processing or for use.

When using the microfluidic mixer, the first and second fluids could be reagents, with the microfluidic mixer being used to mix them to facilitate a chemical reaction. Alternatively the microfluid mixer may be used to mix the first and second fluids (as chemical species or otherwise) to produce a mixture. In some cases the first and second fluids may be biological material and/or medicaments. The same microfluidic mixer might be used for any such purpose on different occasions.

According to a fifth aspect of the invention there is provided a microfluidic mixer system comprising multiple interconnected instances of the microfluidic mixer of the fourth aspect.

In some embodiments the multiple instances of the microfluidic mixer are interconnected in that their fluid collection conduits are arranged to deliver product of mixing to a common outlet. The common outlet may for instance be a common store or an inlet to a device or system for further processing or use. The multiple instances of the microfluidic mixer may therefore be considered to be arranged (e.g. connected) in parallel.

In some embodiments the multiple instances of the microfluidic mixer and their interconnections with the common outlet are arranged so that substantially the same pressure drop occurs for fluid flowing through each of the multiple instances of the microfluidic mixer to the common outlet. It may be for instances that each of the multiple instances of the microfluid mixer are substantially the same and/or have interconnection arrangements to the common outlet which are substantially the same. The multiple instances of the microfluidic mixers may for instance be arranged around the common outlet with interconnections of substantially the same form and dimensions. The microfluidic mixers may for instance be arranged at equally spaced intervals and/or symmetrically around (e.g. radially outwards of and/or in a common radial plane) the common outlet.

In some embodiments the multiple instances of the microfluidic mixer are interconnected in that the fluid collection conduit of a first of the microfluidic mixers is arranged to deliver product of mixing to the at least one first fluid delivery conduit of a second of the microfluidic mixers. This may for instance be via the first reservoir and optionally the first fluid inlet of the second microfluidic mixer. Additionally, this interconnection may be further repeated (e.g. to a third and optionally fourth and optionally so on instances of the microfluidic mixer). The multiple instances of the microfluidic mixer may therefore be considered to be arranged (e.g. connected) in series.

According to a sixth aspect of the invention there is provided a method of manufacturing a microfluidic mixer from a substrate block, the method comprising forming the microfluidic mixer inside the substrate block using selective laser etching.

The selective laser etching may be performed by irradiating parts of the inside of the substrate block that in accordance with the microfluidic mixer design are to constitute voids. These parts may be irradiated around other non-void parts of the design. This may be followed by etching away the irradiated material (e.g. using a substance which etches the irradiated material at a faster rate than non-irradiated material). The irradiation may be by means of a femtosecond laser. The etching may be my means of potassium hydroxide.

In some embodiments the substrate block comprises glass, sapphire or another transparent material.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described by way of example only, with reference to the accompanying drawings, in which:

FIG. 1 shows a perspective view of an embodiment of a microfluidic mixer according to an embodiment of the invention;

FIG. 2 shows a perspective view of a part of the microfluidic mixer of FIG. 1 including a mixing chamber according to an embodiment of the invention;

FIG. 3 shows a top cross-sectional view through a part of the microfluidic mixer of FIG. 1 including a mixing chamber according to an embodiment of the invention;

FIG. 4 shows a top cross-sectional view through a part of the microfluidic mixer of FIG. 1 including a mixing chamber with simulated fluid flows according to an embodiment of the invention;

FIG. 5 shows a perspective view of an embodiment of a microfluidic mixer according to an embodiment of the invention;

FIG. 6 shows a perspective view of a microfluidic mixer system according to an embodiment of the invention; and

FIG. 7 shows a perspective view of a microfluidic mixer system according to an embodiment of the invention.

### DETAILED DESCRIPTION

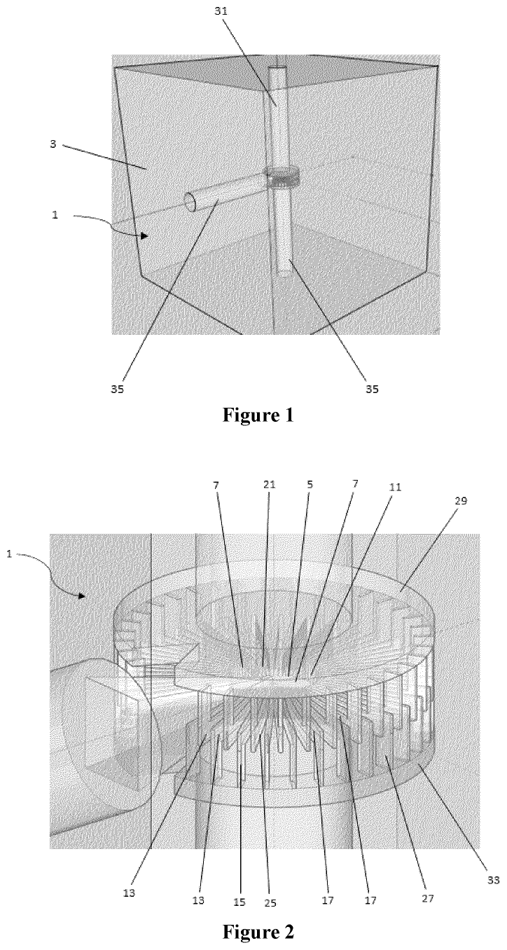

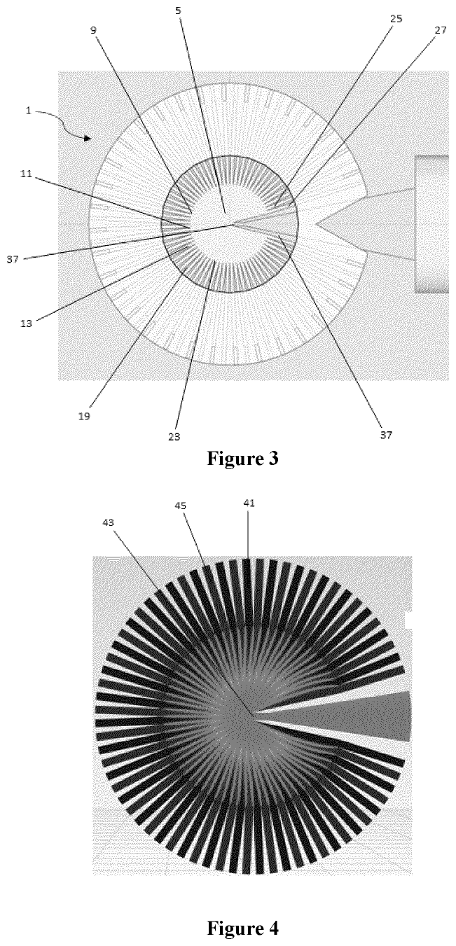

Referring first to FIGS. 1-3, a microfluidic mixer is generally shown at 1. The microfluidic mixer is formed by a series of voids etched into a substrate 3, such that remaining substrate forms walls and other structures of the microfluidic mixer 1. In the embodiment shown, the substrate is fused silica.

The microfluidic mixer 1 has a mixing chamber 5. The mixing chamber 5 is cylindrical with two end walls 7 and a side wall 9. A segment of the side wall 9 is a fluid delivery port portion 11. Radially outwards of the mixing chamber 5 are a plurality of fluid delivery conduits 13. The fluid delivery conduits 13 are regularly spaced and provided around the whole of the fluid delivery port portion 11. Each fluid delivery conduit 13 has an axially extending portion 15 and between the axially extending portion 15 and the fluid delivery port portion 11, a radially extending portion 17. The fluid delivery conduits 13 are adjacent one another, with the radially extending portions 17 of each pair of fluid delivery conduits 13 being separated by a thin, radially extending (common) wall 19. In the embodiment of FIGS. 1-3, 68 fluid delivery conduits 13 are provided. Nonetheless, in other embodiments, other numbers of fluid delivery conduits 13 may be used (e.g. from one up to a limit defined by the manufacturing technique). The walls 19 taper down in the radial direction to an axially extending edge 21 at the fluid delivery port portion 11. These edges 21 define between them, at the fluid delivery port portion 11, respective fluid delivery ports 23. The fluid delivery ports 23 are in this embodiment slot shaped (i.e. axially extending slots). The width of each fluid delivery port 23 (i.e. the distance between the walls 19 at the fluid delivery port 23) is substantially 10 micrometers. In view of the tapering of the walls 19 to the fluid delivery port portion 11, there is substantially no gap between adjacent fluid delivery ports 23.

The fluid delivery conduits 13 are divided between substantially equal numbers of first fluid delivery conduits 25 and second fluid delivery conduits 27. These alternate in the circumferential direction around the mixing chamber 5 and are arranged to deliver a first fluid and a second fluid respectively.

The first fluid delivered is stored in a first reservoir 29. The first reservoir 29 is axially displaced with respect to the mixing chamber 5 (in this case, above the mixing chamber 5). Each axially extending portion 15 of an instance of the first fluid delivery conduits 25 connects the corresponding instance of the radially extending portions 17 to the first reservoir 29, thus providing for fluid communication between the first reservoir 29 and the mixing chamber 5. The first reservoir 29 itself is fed with the first fluid via a first fluid inlet 31, which extends axially, from an external reservoir or supply. The first fluid is delivered under pressure to the first reservoir 29 through the action of a first pump (not shown).

The second fluid delivered is stored in a second reservoir 33. The second reservoir 33 is axially displaced with respect to the mixing chamber 5 (in this case, below the mixing chamber 5). Each axially extending portion 15 of an instance of the second fluid delivery conduits 27 connects the corresponding instance of the radially extending portions 17 to the second reservoir 33, thus providing for fluid communication between the second reservoir 33 and the mixing chamber 5. The second reservoir 33 itself is fed with the second fluid via a second fluid inlet 35, which extends axially, from an external reservoir or supply. The second fluid is delivered under pressure to the second reservoir 33 through the action of a second pump (not shown).

As will be appreciated in accordance with the description above, in the present embodiment the first 29 and second 33 reservoirs are located on opposite sides of the mixing chamber 5, thereby serving to better accommodate the first and second fluids being delivered in substantially opposite, substantially axial directions to sides corresponding to the relevant reservoir 29, 33. Additionally, the axially extending portions 15 of the first fluid delivery conduits 25 project in the opposite direction to the axially extending portions 15 of the second fluid delivery conduits 27.

In the centre of the mixing chamber 5, equidistant each of the fluid delivery ports 23, is a fluid collection port 37. The fluid collection port 37 is part of and feeds the rest of a fluid collection conduit 39. The fluid collection conduit 39 extends in a radial direction and passes through the side wall 9 of the mixing chamber 5 and beyond to a fluid store (not shown). The fluid collection conduit 39 (including the fluid collection port 37) is dimensioned so as to introduce reduced/a minimal pressure drop to the microfluidic mixer 1. It may for instance define an aperture and channel larger in cross-sectional area than the combined cross-sectional area of all of the fluid delivery ports 23.

An example use of the microfluidic mixer 1 is discussed below with further reference to FIG. 4.

Under pressure from the first pump, the first fluid is delivered, via the first fluid inlet 31, to the first reservoir 29 and into the first fluid delivery conduits 25. As the first fluid is forced out of each of the fluid delivery ports 23 of the first fluid delivery conduits 25, it is in each case formed into a radially inwardly directed, laminar stream, each constituting an instance of a first flow 41. Each such first flow 41 is directed towards a common focus point 43, coplanar with the fluid delivery ports 23 and at the centre of the mixing chamber 5.

Under pressure from the second pump, the second fluid is delivered, via the second fluid inlet 35, to the second reservoir 33 and into the second fluid delivery conduits 27. As the second fluid is forced out of each of the fluid delivery ports 23 of the second fluid delivery conduits 27, it is in each case formed into a radially inwardly directed laminar stream, each constituting an instance of a second flow 45. Each such second flow 45 is directed towards the common focus point 43.

Adjacent instances of the first 41 and second 45 flows are in close proximity and interact in a laminar flow regime causing mixing of the first and second fluids by diffusion between adjacent instances of the first 31 and second 45 flows. Further, as the first 31 and second 45 flows travel ever further radially inwards toward the common focus point 43, hydrodynamic focussing occurs, enhancing the mixing effect. Indeed, in the present embodiment, as the first 41 and second 45 flows reach the common focus point 43, they are focused to an extent that their widths are approximately 100 nanometres across.

At the common focus point 43, the now mixed first 41 and second 45 flows have produced a product of mixing, which enters the fluid collection port 37 and fluid collection conduit 39. In view of the laminar flow regime, there is no significant turbulence or swirling, but rather the first 41 and second 45 flows flow directly from the respective fluid delivery ports 23 to the common focus point 43 and into the fluid collection port 37, being mixed on the way to form the product of mixing. The fluid collection conduit 39 transports the product of mixing to the store.

In terms of manufacturing the microfluidic mixer 1, this is performed by selective laser etching inside the substrate 3. This facilitates the generation of the small scales and fine structures indicated. The selective laser etching is used to generate voids in the substrate 3, which correspond to void parts of the microfluidic mixer 1 design (e.g. the mixing chamber 5, the fluid delivery conduits 13, the fluid collection conduit 39, first reservoir 29, first fluid inlet 31, second reservoir 33 and the second fluid inlet 35). The void parts are etched around non-void parts of the microfluidic mixer 1 design (e.g. walls 7, 9 of the mixing chamber 5, walls of the fluid delivery conduits 13 (including the walls 19), wall of the fluid collection conduit 39, wall of the first reservoir 29, wall of the first fluid inlet 31, wall of the second reservoir 33 and second fluid inlet 35). The void parts are first irradiated around the non-void parts of the design using a femtosecond laser. This is followed by etching away the irradiated material using potassium hydroxide.

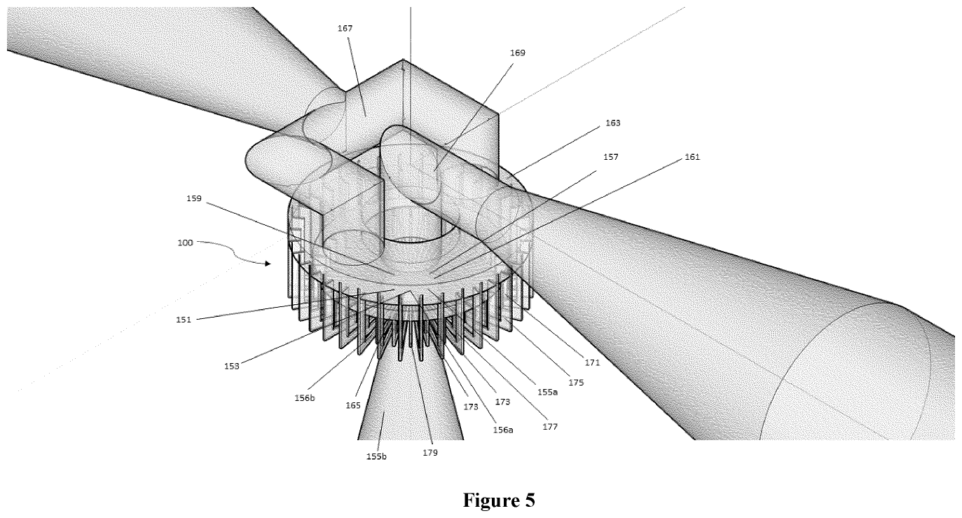

Referring now to FIG. 5 a microfluidic mixer 100 is provided which is somewhat reconfigured by comparison with the microfluidic mixer 1. Only the adjustments to the microfluidic mixer 1 are discussed here, all other aspects being similar to those discussed above with respect to the microfluidic mixer 1.

In the microfluidic mixer 100, a mixing chamber 151, which is cylindrical, has a fluid collection port 153 in the centre of an end wall 155a of the fluid mixing chamber 151. The fluid collection port 153 is part of and leads to the rest of a fluid collection conduit 155b which extends axially away from the mixing chamber 151. This arrangement allows for the mixing chamber 151 to have an uninterrupted internal cavity. Specifically, despite there once again being a common focus point 156a at the centre of the mixing chamber 151 at which the fluid collection port 153 is provided, there is no need for a radially extending wall to define a radially extending fluid collection conduit. This may assist in avoiding ‘edge effects’ resulting from interaction between laminar flow and such a wall, which have the potential to negatively impact on mixing quality and/or pressure drop. Further, this allows for fluid delivery conduits 156b and their associated fluid delivery ports 157 to form a substantially continuous and substantially complete ring around a fluid delivery port portion 159 around a side wall 161 of the mixing chamber 151. Consequently, the fluid delivery port portion 159 and fluid delivery conduits 156b (and indeed their fluid delivery ports 157) may be arranged in a rotationally symmetric manner, rather than in a segment as per the microfluidic mixer 1. This may offer additional utilisation/throughput of fluid, enhanced mixing performance and/or reduced pressure drop.

To complement the alternative fluid collection conduit 155b, additional adjustments are made. Both first 163 and second 165 reservoirs are on the same (in this case upper) side of the mixing chamber 151 (i.e. axially displaced in the same direction) and are supplied with respective first and second fluids from respective first 167 and second 169 fluid inlets to that same side. This is the opposite side of the mixing chamber 151 on which the fluid collection port 153 is provided. Consequently, in this embodiment, axially extending portions 171 of all fluid delivery conduits 173 extend in the same axial direction towards their respective corresponding first 163 and second 165 reservoirs.

Additionally, to better accommodate the first 163 and second 165 reservoirs to the same side of the mixing chamber 151, the first 163 and second 165 chambers are axially displaced and the second reservoir 165 has a smaller diameter than the first 163. This allows first fluid delivery conduits 175 of the fluid delivery conduits 173 to better access the first reservoir 163 around the radially outer edge of the second reservoir 165. Radial portions 177 of second fluid delivery conduits 179 of the fluid delivery conduits 173 are somewhat foreshortened, to better allow the second fluid delivery conduits 179 to access the second reservoir 165. Additionally, the first reservoir 163 has a substantially toroidal shape, to thereby accommodate the second fluid inlet 169 passing through the centre thereof to access the second reservoir 165.

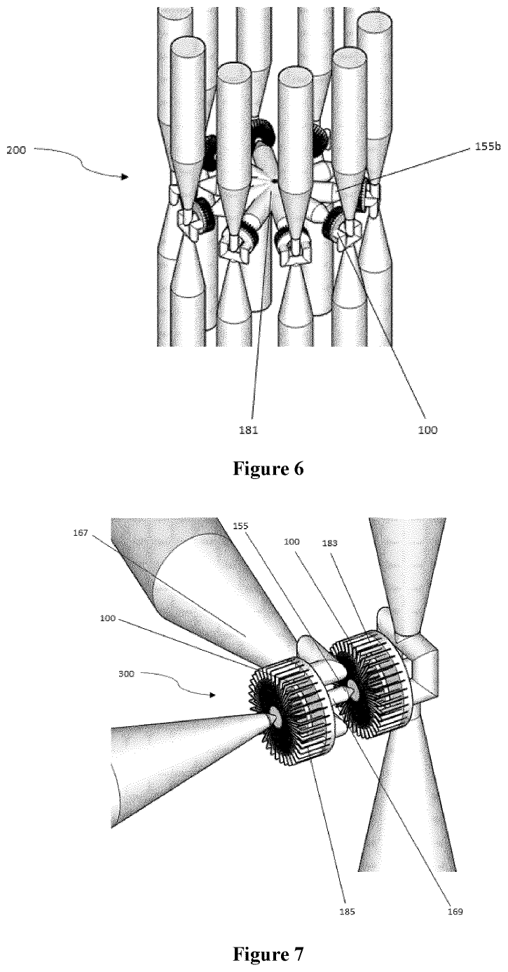

Referring now to FIG. 6, a microfluidic mixer system is generally shown at 200. The microfluidic mixer system comprises multiple interconnected instances of the microfluidic mixer 100 (in this case ten instances). The fluid collection conduit 155b of each of the microfluidic mixers is arranged to deliver the product of mixing to a common outlet 181. In this case, the common outlet 181 is centralised between the multiple instances of the microfluidic mixer 100. In this case, the microfluidic mixers 100 may be considered connected in parallel. With each of the microfluidic mixers 100 mixing the same fluids, the overall volume of the product of mixing generated may be significantly higher, without adjusting the characteristics (e.g. dimensions) of the microfluidic mixers.

Referring now to FIG. 7 a microfluidic mixer system is generally shown at 300. The microfluidic mixer system comprises multiple interconnected instances of the microfluidic mixer 100 (in this case two instances). The fluid collection conduit 155 b of an upstream 183 of the microfluidic mixers 100 is arranged to deliver its product of mixing to the second fluid inlet 169 of a downstream 185 of the microfluidic mixers. A third fluid is provided to the first fluid inlet 167 of the downstream 185 microfluidic mixer. In this case, the microfluidic mixers 100 may be considered connected in series, allowing for successive mixing operations.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A microfluidic mixer arranged to mix a first fluid and a second fluid, the microfluidic mixer comprising a mixing chamber and fluid delivery conduits each having a respective fluid delivery port into the mixing chamber,
the fluid delivery conduits comprising at least one first fluid delivery conduit arranged to deliver the first fluid into the mixing chamber and at least one second fluid delivery conduit arranged to deliver the second fluid into the mixing chamber,
wherein the mixing chamber has a fluid delivery port portion having a cross-section that is at least substantially circular and the fluid delivery conduits are disposed radially outwards of the delivery port portion and such that the fluid delivery ports form a substantially continuous and substantially complete ring around the fluid delivery port portion,
and where further the at least one first fluid delivery conduit is arranged so that first fluid delivered by each of the at least one first fluid delivery conduits forms a respective first flow in the mixing chamber and the at least one second fluid delivery conduit is arranged so that second fluid delivered by each of the at least one second fluid delivery conduits forms a respective second flow in the mixing chamber,
and where the fluid delivery conduits are arranged so that the first and second flows are focussed at a substantially common focus point within the mixing chamber.

2. A microfluidic mixer according to claim 1, where the substantially common focus point is located at substantially the centre of the mixing chamber.

3. A microfluidic mixer according to claim 1, comprising a fluid collection conduit having a fluid collection port where the fluid collection port is provided at the substantially common focus point and the fluid collection conduit is arranged to receive the product of mixing the first and second fluids in the mixing chamber.

4. A microfluidic mixer according to claim 3, where the fluid collection port is provided in an end wall of the mixing chamber or the fluid collection conduit passes through the end wall.

5. A microfluidic mixer according to claim 3, where each fluid delivery conduit comprises a radially extending portion extending substantially radially outwards from its fluid delivery port at the mixing chamber and the radially extending portions are formed between radially extending walls each tapered substantially to an edge at the mixing chamber.

6. A microfluidic mixer according to claim 1, at least part of which is formed by the removal of material from within a substrate block.

7. A microfluidic mixer according to claim 6, where the material removal is performed by selective laser etching.

8. A microfluidic mixer system comprising multiple interconnected instances of the microfluidic mixer of claim 1.

9. A microfluidic mixer system according to claim 8, where the multiple instances of the microfluidic mixer are interconnected in that their fluid collection conduits are arranged to deliver product of mixing to a common outlet.

10. A microfluidic mixer system of claim 8, where the multiple instances of the microfluidic mixer are interconnected in that the fluid collection conduit of a first of the microfluidic mixers is arranged to deliver product of mixing to the at least one first fluid delivery conduit of a second of the microfluidic mixers.

11. A method of mixing a first fluid and a second fluid in a microfluidic manner, the method comprising, delivering a first fluid in at least one first flow and a second fluid in at least one second flow from positions which define a substantially continuous and substantially complete ring of a substantially circular shape towards a substantially common focus point.

12. A microfluidic mixer according to claim 1 formed by the removal of material from within a substrate block by selective laser etching.

13. A microfluidic mixer according to claim 12, arranged to mix a first fluid and a second fluid, the microfluidic mixer comprising a mixing chamber and fluid delivery conduits each having a respective fluid delivery port into the mixing chamber, the fluid delivery conduits comprising at least one first fluid delivery conduit arranged to deliver the first fluid into the mixing chamber and at least one second fluid delivery conduit arranged to deliver the second fluid into the mixing chamber and where the at least one first fluid delivery conduit is arranged so that first fluid delivered by each of the first fluid delivery conduits forms a respective first flow in the mixing chamber and the at least one second fluid delivery conduit is arranged so that second fluid delivered by each of the second fluid delivery conduits forms a respective second flow in the mixing chamber, where each first flow is adjacent to at least one of the second flows or another of the first flows and each second flow is adjacent to at least one of the first flows or another of the second flows and where the fluid delivery conduits are arranged so that the first and second flows are focussed at a substantially common focus point within the mixing chamber.

14. A microfluidic mixer system comprising multiple interconnected instances of the microfluidic mixer of claim 1.

15. A method of manufacturing a microfluidic mixer from a substrate block, the method comprising forming the microfluidic mixer inside the substrate block using selective laser etching.
